(19) United States
(12) Patent Application Publication
(10) Pub. No.: US 2023/0304975 A1
(43) Pub. Date: Sep. 28, 2023

(54) PEAK SHAPE ESTIMATION DEVICE AND PEAK SHAPE ESTIMATION METHOD

(71) Applicant: SHIMADZU CORPORATION, Kyoto-shi (JP)

(72) Inventor: Yusuke TAMAI, Kyoto-shi (JP)

(21) Appl. No.: 18/023,346

(22) PCT Filed: Mar. 3, 2021
(86) PCT No.: PCT/JP2021/008190

§ 371 Date: Feb. 25, 2023

(30) Foreign Application Priority Data
Aug. 27, 2020 (JP) 2020-143690

(51) Int. Cl. G01N 30/86; G06N 7/01

(52) U.S. Cl. CPC G01N 30/8637; G01N 30/8675; G01N 30/8693; G06N 7/01

(57) ABSTRACT

An acquirer that acquires, based on measurement data acquired over time using an analysis device, measurement waveform data, the measurement data representing a change in domain direction of the measurement data, and an estimator that acquires estimation waveform data that is what noise data is at least partially removed from the measurement waveform data, are included. The estimator acquires the estimation waveform data as data such that the noise data included in the measurement waveform data has a correlation in the domain direction. Thus, a peak shape can be correctly estimated based on measurement waveform data to which noise is added.

### TECHNICAL FIELD

The present invention relates to a device and a method for estimating a peak shape based on measurement waveform data.

### BACKGROUND ART

An analysis device such as a chromatograph or a mass spectrometer outputs waveform data as a result of analysis. A qualitative analysis of a sample to be analyzed is performed based on the position of a peak appearing in waveform data. Further, a quantitative analysis of a sample is performed based on the shape of a peak appearing in waveform data.

Peak waveform models such as a Gaussian function, an EMG (Exponentially Modified Gaussian) function and a BEMG (Bidirectional Exponentially Modified Gaussian) function are used for estimation of the shape of a peak appearing in waveform data. Patent Document 1 and Non-Patent Document 1, described below, disclose methods of estimating a peak shape with use of a BEMG function.

[Patent Document 1] JP 6260709 B2

[Non-Patent Document 1] Arase, Shuntaro, et al. “Intelligent peak deconvolution through in-depth study of the data matrix from liquid chromatography coupled with a photo-diode array detector applied to pharmaceutical analysis.” Journal of Chromatography A, 2016, vol.1469, P35-47.

### SUMMARY OF INVENTION

### Technical Problem

Noise may be added to or a plurality of peaks may be superimposed in the waveform data output from an analysis device. In such a case, a peak shape may not be accurately observed based on the waveform data. As a method of estimating a peak shape based on the waveform data to which noise or the like is added, there is a method of adding an error term to a peak waveform model. For example, with the least squares method, an error term is added to a peak waveform model on the assumption that noise that is independent of the observation time and follows a normal distribution is added. Then, a parameter value of the peak waveform model is calculated with optimization and with use of a sequential algorithm such as Markov chain Monte Carlo (MCMC), whereby an error term is excluded, and a true peak shape is estimated.

However, it has been known that, in a case in which it is assumed that noise that is independent of the observation time and follows a normal distribution is added to the waveform data, a local solution is generated due to tailing of a peak in a process of estimating a peak shape. When a local solution is generated, optimization or sampling is not effectively performed. Thus, a peak shape may not be estimated correctly.

An object of the present invention is to correctly estimate a peak shape based on waveform data to which noise is added.

### Solution to Problem

A peak shape estimation device according to one aspect of the present invention is realized by a computer including a processing unit, wherein the processing unit includes an acquirer that acquires, based on measurement data acquired over time using an analysis device, measurement waveform data, the measurement waveform data representing a change in domain direction of the measurement data, and an estimator that acquires estimation waveform data that is what noise data is at least partially removed from the measurement waveform data, and wherein the estimator acquires the estimation waveform data as data such that the noise data included in the measurement waveform data has a correlation in the domain direction.

### Advantageous Effects of Invention

With the present invention, a peak shape can be correctly estimated based on waveform data to which noise is added.

### BRIEF DESCRIPTION OF THE DRAWINGS

FIG. 1 is a diagram showing the configuration of a peak shape estimation device according to the present embodiment.

FIG. 2 is a block diagram showing the functions of the peak shape estimation device according to the present embodiment.

FIG. 3 is a diagram showing waveform data of a peak with tailing and a peak without tailing.

FIG. 4 is a flowchart showing a peak shape estimation method according to the present embodiment.

FIG. 5 is a diagram showing observed waveform data and a peak shape estimated when it is assumed that noise follows a time-series model.

FIG. 6 is a diagram showing observed waveform data and a true peak shape.

FIG. 7 is a diagram showing observed waveform data and a peak shape estimated when it is assumed that noise is independent of the observation time.

FIG. 8 shows violin plots representing distributions of estimated peak areas.

### DESCRIPTION OF EMBODIMENTS

A peak shape estimation device and a peak shape estimation method according to embodiments of the present invention will now be described with reference to the attached drawings.

### Configuration of Peak Shape Estimation Device

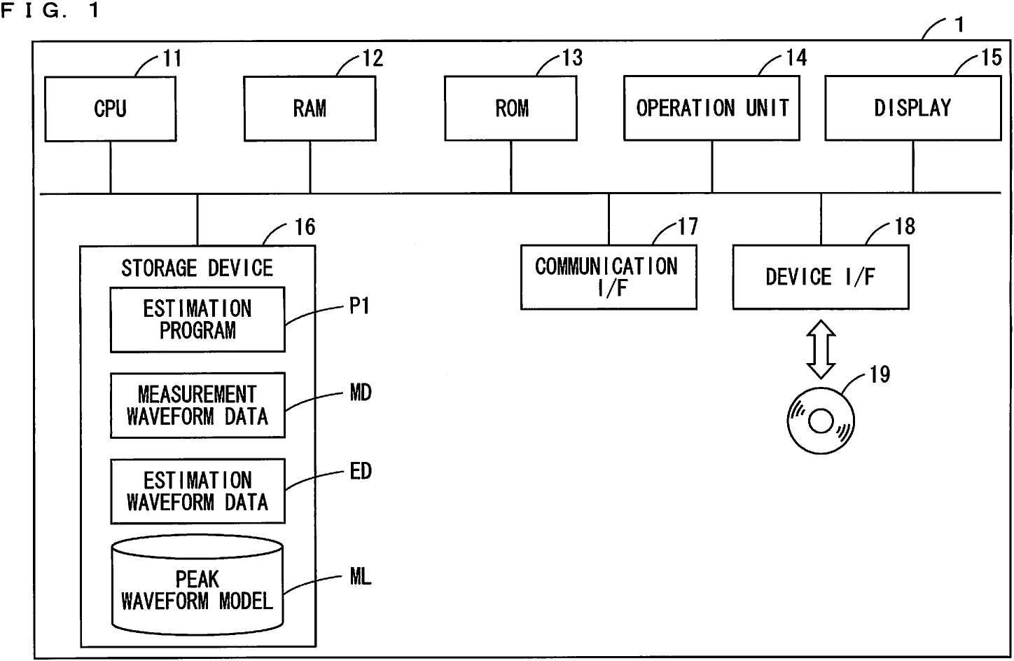

FIG. 1 is a diagram showing the configuration of the peak shape estimation device 1 according to an embodiment. The peak shape estimation device 1 is a computer such as a personal computer. The peak shape estimation device 1 of the present embodiment acquires measurement data of a sample obtained in a liquid chromatograph, a gas chromatograph, a mass spectrometer or the like. Further, the peak shape estimation device 1 is a device that estimates a peak shape based on the measurement data of a sample.

As shown in FIG. 1, the peak shape estimation device 1 includes a CPU (Central Processing Unit) 11, a RAM (Random Access Memory) 12, a ROM (Read Only Memory) 13, an operation unit 14, a display 15, a storage device 16, a communication interface (I/F) 17 and a device interface (I/F) 18.

The CPU 11 controls the peak shape estimation device 1 as a whole. The RAM 12 is used as a work area for execution of a program by the CPU 11. A control program and so on are stored in the ROM 13. The operation unit 14 receives an input operation performed by a user. The operation unit 14 includes a keyboard, a mouse, etc. The display 15 displays information such as a result of analysis.

The storage device 16 is a storage medium such as a hard disc. In the storage device 16, an estimation program P1, measurement waveform data MD, estimation waveform data ED and a peak waveform model ML are stored.

The estimation program P1 executes an estimation process on the measurement waveform data MD and outputs the estimation waveform data ED. In the measurement waveform data MD, noise may be added, or a plurality of peaks may be superimposed. The estimation program P1 executes the estimation process on the measurement waveform data MD to obtain the estimation waveform data ED representing a true peak shape. When executing the estimation process, the estimation program P1 executes a process of fitting the peak waveform model ML to the measurement waveform data MD. The peak waveform model ML includes a Gaussian function, an EMG (Exponentially Modified Gaussian) function, a BEMG (Bidirectional Exponentially Modified Gaussian) function and the like.

The communication interface 17 is an interface that communicates with another computer through wireless or wired communication. The device interface 18 is an interface that accesses a storage medium 19 such as a CD, a DVD or a semiconductor memory.

### Functional Configuration of Peak Shape Estimation Device

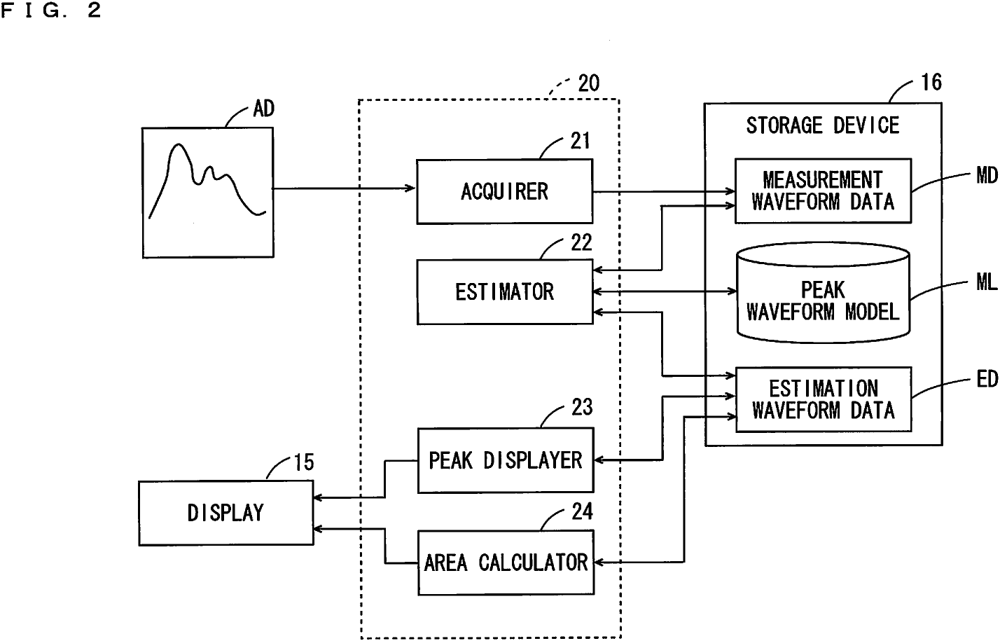

FIG. 2 is a block diagram showing the functional configuration of the peak shape estimation device 1. In FIG. 2, a controller 20 is a function that is implemented by execution of the estimation program P1 by the CPU 11 while the CPU 11 uses the RAM 12 as a work area. The controller 20 includes an acquirer 21, an estimator 22, a peak displayer 23 and an area calculator 24. That is, the acquirer 21, the estimator 22, the peak displayer 23 and the area calculator 24 are the functions implemented by execution of the estimation program P1. In other words, the acquirer 21, the estimator 22, the peak displayer 23 and the area calculator 24 are the functions included in the CPU 11.

The acquirer 21 receives measurement data AD. The acquirer 21 receives the measurement data AD from another computer via the communication interface 17, for example. Alternatively, the acquirer 21 receives the measurement data AD saved in the storage medium 19 via the device interface 18. The measurement data AD is analysis data of a sample acquired over time in a liquid chromatograph, a gas chromatograph, a mass spectrometer or the like. In a case in which being analysis data obtained in a chromatograph, the measurement data AD is three-dimensional chromatogram data having three dimensions of time, a wavelength and an absorbance (signal intensity). In a case in which being analysis data obtained in a mass spectrometer, the measurement data AD is mass spectrometric data having three dimensions of time, a mass-to-charge ratio and ionic strength (a signal intensity).

The acquirer 21 extracts the measurement waveform data MD from the received measurement data AD and saves the measurement waveform data MD in the storage device 16. The measurement waveform data MD is two-dimensional data extracted from the measurement data AD. For example, the measurement waveform data MD is two-dimensional chromatogram data representing the relationship between time and an absorbance. Alternatively, the measurement waveform data MD is two-dimensional mass spectrometric data representing the relationship between time and ionic strength.

The estimator 22 reads the measurement waveform data MD and the peak waveform model ML, and fits the peak waveform model ML to the measurement waveform data MD. The estimator 22 obtains the estimation waveform data ED by performing Bayesian inference using the peak waveform model ML as a prior distribution.

The peak displayer 23 outputs the estimation waveform data ED estimated by the estimator 22 to the display 15. The area calculator 24 calculates a peak area of the estimation waveform data ED estimated by the estimator 22. The area calculator 24 also outputs the violin plot of the calculated peak area to the display 15.

### Noise and Superimposition of Peaks

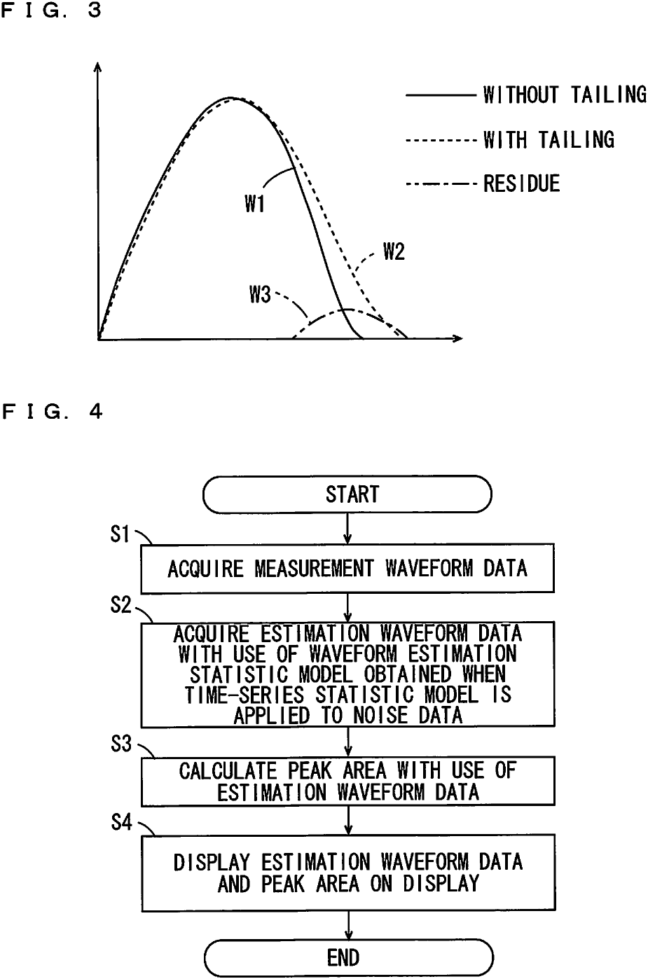

Next, noise and superimposition of a plurality of peaks included in the measurement waveform data MD will be described. FIG. 3 is a diagram showing the measurement waveform data MD. In FIG. 3, a waveform W1 shows a peak shape without tailing, and a waveform W2 shows a peak shape with tailing. Further, a waveform W3 is a residue of the waveform W1 and the waveform W2. In a case in which a peak of an impurity overlaps with the waveform W3, it is not unnatural as a result of analysis to interpret the waveform having the overlap as an impurity. It has been known that, in a case in which an error term factored in the peak waveform model is treated as noise that is independent of the observation time and follows a normal distribution, a local solution is generated due to tailing of a peak, and optimization and sampling are not very accurate. That is, it is difficult to distinguish between a waveform having a single peak with tailing and a waveform in which a large error is added to a shoulder of a peak without tailing. Further, it is difficult to distinguish between a waveform having a single peak with tailing and a waveform in which a peak of another component is superimposed.

The inventor of the present application has found that such an estimation error occurs because noise that is dependent on noise adjacent in a time direction such as tailing, that is, noise having a correlation in the time direction is treated as Gaussian noise independent of the observation time. As such, the peak shape estimation device 1 of the present embodiment treats noise as data following a time-series model, thereby improving the accuracy of estimation of a peak shape.

### Peak Shape Estimation Method

Next, the peak shape estimation method according to the present embodiment will be described. FIG. 4 is a flowchart showing the peak shape estimation method according to the present embodiment. First, in the step S1, the acquirer 21 (see FIG. 2) receives the measurement data AD and acquires the measurement waveform data MD based on the measurement data AD. Here, as an example, the measurement data AD is three-dimensional chromatogram data having three dimensions of time, a waveform and an absorbance (signal intensity) acquired from a liquid chromatograph. Further, the measurement waveform data MD is two-dimensional chromatogram data representing the relationship between the time and an absorbance.

Next, in the step S2, the estimator 22 (see FIG. 2) reads the measurement waveform data MD and uses the peak waveform model ML to acquire the estimation waveform data ED. At this time, the estimator 22 adds noise data following the time-series model as an error term to the peak waveform model ML.

In the present embodiment, the estimator 22 uses a BEMG (Bidirectional Exponentially Modified Gaussian) function as the peak waveform model ML. Further, the estimator 22 obtains the estimation waveform data ED by performing Bayesian inference using the peak waveform model ML as a prior distribution. The formula 1 expresses the BEMG function.

### Formula 1

$$\begin{matrix}\text{BEMG} \left(\text{x} \left|\text{u} \text{. s, a} \text{. b}\right)\right) = \\ \frac{\text{ab}}{2 \text{a+2b}} \left\{exp \left(\frac{{\text{b}}^{2} {\text{s}}^{2}}{2} + \text{b} \left(\text{u} - \text{x}\right)\right) ∗ \text{erfc} \left(\frac{{\text{bs}}^{2} \text{+u} - \text{x}}{\sqrt{2 \text{s}}}\right) + exp \left(\frac{{\text{a}}^{2} {\text{s}}^{2}}{2} + \text{a} \left(\text{x} - \text{u}\right)\right) ∗ \text{erfc} \left(\frac{{\text{as}}^{2} - \text{u+x}}{\sqrt{2 \text{s}}}\right)\right\}\end{matrix} \qquad \text{(Formula 1)}$$

In the formula 1, ‘u’ is a parameter for a peak position, ‘s’ is a parameter for a peak width, ‘a’ is a parameter for leading and ‘b’ is a parameter for tailing.

Because the measurement waveform data MD is taken as the data in which a peak represented by the BEMG function is superimposed, the estimation waveform data ED can be expressed by the formula 2.

### Formula 2

$$\text{y=} {\sum }_{\text{i =1}}^{\text{K}} {\text{A}}_{\text{i}} \times \text{BEMG} \left(\text{x} \left|{\text{u}}_{\text{i}} , {\text{s}}_{\text{i}} , {\text{a}}_{\text{i}} , {\text{b}}_{\text{i}}\right)\right) + \text{Noise} \left[\text{t}\right] \qquad \text{(Formula 2)}$$

In the formula 2, K is the number of peaks to be superimposed. Ai is a coefficient for each peak. Noise [t] is an error term. In the present embodiment, the estimator 22 treats Noise [t] following the time-series model as an error term. The formula 3 expresses an error term.

### Formula 3

$$\begin{matrix}\text{Noise} \left[\text{t}\right] = θ \times \text{Noise} \left[\text{t} - \text{1}\right] + {ε}_{\text{t}} \\ {ε}_{\text{t}} \sim \text{N} \left(0. {σ}^{2}\right)\end{matrix} \qquad \text{(Formula 3)}$$

Noise [t] expressed by the formula 3 represents an error term in regard to the t-th observation point from an observation start point in order of elution. Further, N (0, _{σ}²) represents a normal distribution in which an average is 0 and a variance is _{σ}². Further, θ is a coefficient representing auto-correlation. θ, _{σ}² and the first error term Noise[1] are suitably and appropriately set as parameters by a user. That is, Noise[t] has an error component (θ x Noise[t-1]) having a correlation in the time direction and an error component (εt) that is independent of the time. In this manner, in the present embodiment, the estimator 22 utilizes a time-series model referred to as an Auto Regressive Model of order 1 as an error term.

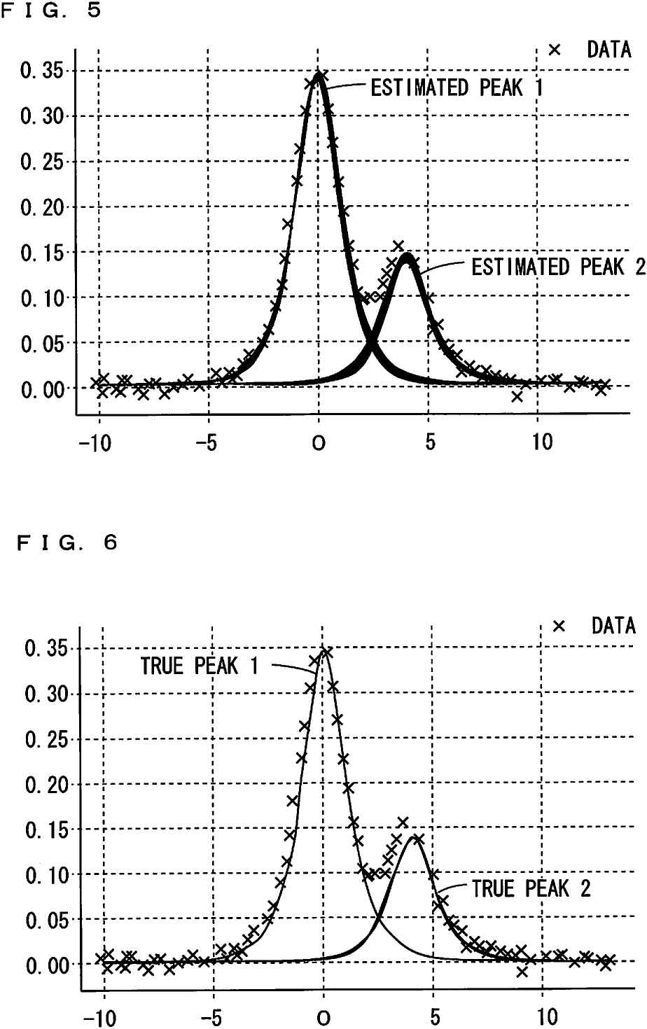

The estimator 22 utilizes the peak waveform model ML and the error term expressed by the formulas 1 to 3, and performs optimization or executes a sequential algorithm such as a Markov Chain Monte Carlo method (MCMC), to obtain the estimation waveform data ED. The estimator 22 saves the acquired estimation waveform data ED in the storage device 16. FIG. 5 is a diagram showing the estimation waveform data ED acquired by the estimator 22. Further, FIG. 6 is a diagram showing the true waveform data corresponding to the estimation waveform data ED shown in FIG. 5. The true waveform data shown in FIG. 6 is a waveform obtained when appropriate parameters are set in the BEMG function, for example.

In FIG. 5, the estimation waveform data ED includes an estimated peak 1 and an estimated peak 2. In FIG. 6, a true peak 1 and a true peak 2 are included. In FIGS. 5 and 6, x indicates the measurement waveform data MD. In FIG. 5, each peak waveform is thick. The reason for this is because the estimation waveform data ED is estimated with use of Bayesian inference, thereby having a probability distribution. Further, the estimation waveform data ED of FIG. 5 is a result obtained when the estimation process is executed 100 times independently with different initial values (Noise [1] in the formula 3). Therefore, each peak waveform is thick also because the results of estimation executed 100 times are depicted. Although each peak waveform is thick, substantially the same peak shapes are depicted. Therefore, the estimation waveform data ED represents that the estimation process has been executed independently of initial values.

As shown in FIGS. 5 and 6, there is no large deviation between the estimated peak 1 and the true peak 1 or between the estimated peak 2 and the true peak 2. It can be seen that estimation is accurate. Further, as shown in FIG. 5, there is also no unnatural deviation between the estimation waveform data ED and the measurement waveform data MD indicated by x. It can be seen that the estimation is accurate. In this manner, the peak shape estimation device 1 of the present embodiment can remove noise data from the measurement waveform data MD accurately. It is desirable, of course, to remove original noise completely. However, with the peak shape estimation device 1 of the present embodiment, the original noise is removed at least partially accurately, so that a true peak can be estimated.

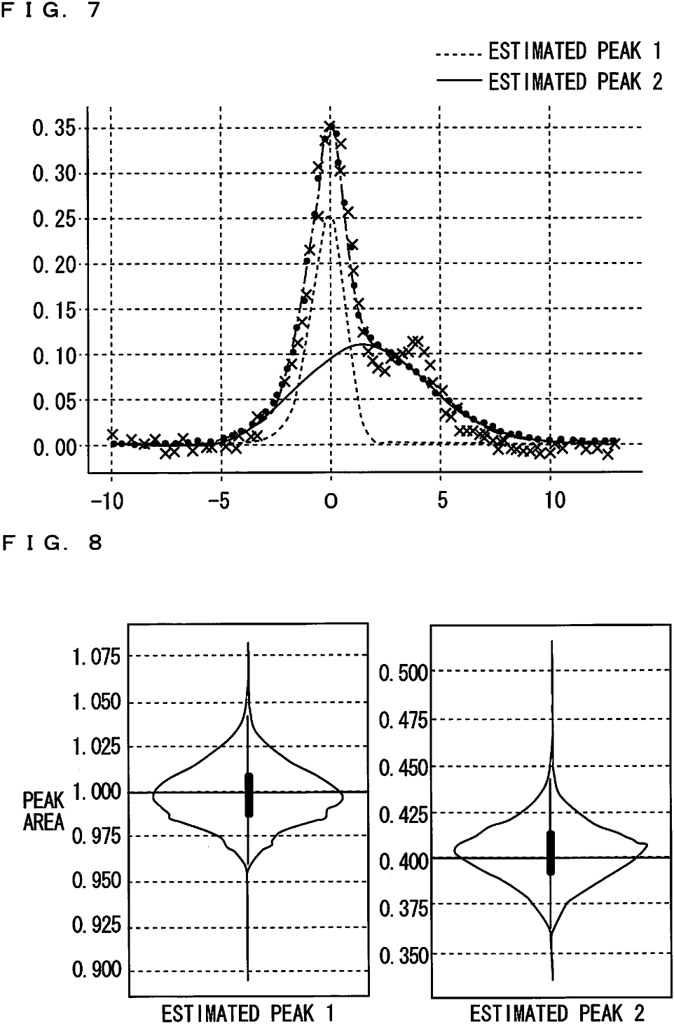

FIG. 7 shows the waveform data obtained when a peak shape is estimated in regard to the same measurement waveform data MD with use of a conventional method. The conventional method is a method of estimating a peak shape on the assumption that noise that is independent of the observation time and follows a normal distribution is added to the measurement waveform data MD. In FIG. 7, two peak shapes of an estimated peak 1 and an estimated peak 2 are estimated. In FIG. 7, the waveform indicated by the broken line is the estimated peak 1, and the waveform indicated by the solid line is the estimated peak 2. In FIG. 7, the line connecting points indicated by black circles is the waveform obtained when the estimated peak 1 and the estimated peak 2 are added. That is, the line connecting the black circles is the estimation waveform data having no error term. Further, similarly to FIGS. 5 and 6, the measurement waveform data MD is indicated by x. As shown in FIG. 7, when the estimation waveform data indicated by the line connecting the black circles and the measurement waveform data MD are compared with each other, it can be seen that there is an unnatural deviation in the shoulder portion of a peak, and the wavy shape in the measurement waveform data MD is ignored.

The result shown in FIG. 7 means that an error term continuously takes a large value. That is, the error terms at adjacent points have a correlation. However, in the example shown in FIG. 7, since it is assumed that the error terms are independent with one another at respective points, there is no restriction on the correlation among adjacent points. Therefore, it can be seen that the wavy shape is processed as independent Gaussian noise at respective points.

In contrast, in the peak shape estimation device 1 of the present embodiment, an Auto Regressive Model, which is a time-series model, is used to estimate an error term. That is, it is assumed that there is a correlation among adjacent points in regard to an error term. Thus, it is possible to generate a model in which an error term having a strong correlation as shown in FIGS. 5 and 6 are factored. Therefore, it is considered that, a local solution and a global solution are smoothly connected to each other, and it is easy to move between the local solution and the global solution when parameters are updated with use of a sequential algorithm.

Description returns to the flowchart of FIG. 4. Next, in the step S3, the area calculator 24 (see FIG. 2) calculates the peak areas in regard to the estimated peak 1 and the estimated peak 2. In the present embodiment, the estimation waveform data ED has a probability distribution because being estimated with use of Bayesian inference. Therefore, a peak area calculated by the area calculator 24 also has a probability distribution.

Next, in the step S4, the peak displayer 23 and the area calculator 24 (see FIG. 2) display a result of estimation on the display 15. The peak displayer 23 displays the peak shape of the estimation waveform data ED as shown in FIG. 5 on the display 15. At this time, the peak displayer 23 also displays the measurement waveform data MD (the data indicated by x in FIG. 5), so that the accuracy of the estimation process can be viewed.

Further, the area calculator 24 displays an estimated peak area on the display 15. FIG. 8 shows the violin plots of the peak areas displayed on the display 15 by the area calculator 24. In FIG. 8, each ordinate represents a peak area, and each abscissa represents the probability density of the estimated peak 1 or the estimated peak 2 symmetrically. It can be seen that the peak area of the estimated peak 1 is distributed around 1.000, and the peak area of the estimated peak 2 is distributed around 0.400. The user can view the accuracy of the estimation process with reference to this estimation information of the peak area.

### Correspondences Between Constituent Elements in Claims and Parts in Preferred Embodiments

In the following paragraphs, non-limiting examples of correspondences between various elements recited in the claims below and those described above with respect to various preferred embodiments of the present disclosure are explained. In the above-mentioned embodiment, the CPU 11 is an example of a processing unit. In the above-mentioned embodiment, a liquid chromatograph, a gas chromatograph or a mass spectrometer is an example of an analysis device. Further, in the above-mentioned embodiment, the time direction is an example of a domain direction.

As each of constituent elements recited in the claims, various other elements having configurations or functions described in the claims can be also used.

### Other Embodiments

In the above-mentioned embodiment, two peaks can be separated by the peak estimation process. This is merely an example, and the peak shape estimation device 1 of the present embodiment can separate three or more peaks by executing the similar estimation process as described above.

In the above-mentioned embodiment, an error term is treated as a time-series model, and an Auto Regressive Model of first order is utilized. Additionally, as a time-series model representing an error term, an Auto Regressive Model of second or higher order, a moving average model, an autoregressive moving average model, an autoregressive integrated moving average model, a state space model, any combination of these, etc. can be used.

In the above-mentioned embodiment, an error term is processed as a model having a correlation in the time direction. The peak shape estimation device 1 of the present embodiment is also applicable in a case in which an error term has a correlation with a parameter other than the time. That is, the present invention is applicable in a case in which an error term has a correlation in a domain direction when a signal intensity is obtained in regard to a domain of a certain parameter.

In the above-mentioned embodiment, a peak shape is estimated on the assumption that an error term has a correlation in the domain direction. That is, the peak shape is estimated by adding of an error term expressed by the formula 3 to the peak waveform model ML expressed by the formula 1. As another application example of the present invention, the peak shape estimation device can also work as an abnormality detection device by estimating a peak shape using a similar method.

In the error term expressed by the formula 3, θ is a coefficient representing auto-correlation. Normally, in a case in which time-series noise is not present, and only noise that is independent of the time is generated, the term for θ is to be a very small value close to 0. In a case in which the value for θ is large, on the contrary, an analysis condition may be incorrect, and a normal analysis may not be performed. In a case in which the value for θ exceeds a threshold value, for example, it is processed as abnormality detection. Therefore, the device and the method of the present invention can be applied as an abnormality detection device and an abnormality detection method.

In the above-mentioned embodiment, the estimation program P1 is stored in the storage device 16, by way of example. In another embodiment, the estimation program P1 may be provided in the form of being stored in the storage medium 19. The CPU 11 of the peak shape estimation device 1 may access the storage medium 19 via the device interface 18 and may store the estimation program P1 stored in the storage medium 19 in the storage device 16 or the ROM 13. Alternatively, the CPU 11 may access the storage medium 19 via the device interface 18 and may execute the program P1 stored in the storage medium 19.

The specific configuration of the present invention is not limited to the above-mentioned embodiments, and various changes and modifications can be made without departing the gist of the invention.

### Aspects

It will be appreciated by those skilled in the art that the exemplary embodiments described above are illustrative of the following aspects.

(Item 1) A peak shape estimation device according to one aspect of the present invention is realized by a computer including a processing unit, wherein the processing unit includes an acquirer that acquires, based on measurement data acquired over time using an analysis device, measurement waveform data, the measurement waveform data representing a change in domain direction of the measurement data, and an estimator that acquires estimation waveform data that is what noise data is at least partially removed from the measurement waveform data, and wherein the estimator acquires the estimation waveform data as data such that the noise data included in the measurement waveform data has a correlation in the domain direction.

The estimation waveform data, which is obtained when noise is removed from the measurement waveform data to which noise is added, can be estimated correctly. Thus, a peak shape excluding noise can be correctly estimated.

(Item 2) The peak shape estimation device according to item 1, wherein the estimator may add a time-series model as the noise data to a peak waveform data for estimating a peak shape included in the measurement waveform data.

A peak shape can be estimated correctly based on the measurement waveform data including noise having a correlation in a time direction.

(Item 3) The peak shape estimation device according to item 2, wherein one model selected as the time-series model from the group consisting of an auto regressive model, a moving average model, an autoregressive moving average model, an autoregressive integrated moving average model, a state space model and any combination of the auto regressive model, the moving average model, the autoregressive moving average model, the autoregressive integrated moving average model and the state space model may be used.

Noise having a correlation in the time direction can be estimated.

(Item 4) The peak shape estimation device according to any one of items 1 to 3, wherein the processing unit may further include an area calculator that calculates a peak area with use of the estimation waveform data.

A user can view the accuracy of estimation by referring to a peak area.

(Item 5) The peak shape estimation device according to any one of items 1 to 4, wherein the estimator may acquire the estimation waveform data with use of Bayesian inference.

A probability distribution of the estimation waveform data can be obtained with use of Bayesian inference.

(Item 6) A peak shape estimation device according to another aspect of the present invention is realized by a computer including a processing unit, wherein the processing unit includes an acquirer that acquires, based on measurement data acquired over time using an analysis device, measurement waveform data, the measurement waveform data representing a change in domain direction of the measurement data, and an estimator that estimates noise data included in the measurement waveform data, and the estimator processes the noise data included in the measurement waveform data as data having a correlation in the domain direction, and detects an abnormality in a case in which a correlation coefficient of the domain direction of the noise data exceeds a predetermined threshold value.

An abnormality of an analysis condition or the like can be detected with use of a correlation of noise.

(Item 7) A peak shape estimation method according to another aspect of the present invention includes an acquiring step of acquiring, based on measurement data acquired over time using an analysis device, measurement waveform data, the measurement waveform data representing a change in domain direction of the measurement data; and an estimating step of acquiring estimation waveform data that is what noise data is at least partially removed from the measurement waveform data, wherein in the estimating step, the estimation waveform data is acquired as data such that the noise data included in the measurement waveform data has a correlation in the domain direction.

(Item 8) A peak shape estimation method according to another aspect of the present invention include an acquiring step of acquiring, based on measurement data acquired over time using an analysis device, measurement waveform data, the measurement waveform data representing a change in domain direction of the measurement data, and an estimating step of estimating noise data included in the measurement waveform data, wherein in the estimating step, the noise data included in the measurement waveform data is processed as data having a correlation in the domain direction, and an abnormality is detected in a case in which a correlation coefficient of the domain direction of the noise data exceeds a predetermined threshold value.

1. A peak shape estimation device realized by a computer including a processing unit, wherein
the processing unit includes
an acquirer that acquires, based on measurement data acquired over time using an analysis device, measurement waveform data, the measurement waveform data representing a change in time direction of the measurement data, and
an estimator that acquires estimation waveform data that is what noise data is at least partially removed from the measurement waveform data, and wherein
the estimator estimates a peak shape included in the measurement waveform data with use of a peak waveform model to which an error term having a correlation in the time direction is added, and thus acquires the estimation waveform data.

2. The peak shape estimation device according to claim 1, wherein
the estimator adds a time-series model as the noise data to the peak waveform data.

3. The peak shape estimation device according to claim 2, wherein
one model selected as the time-series model from the group consisting of an auto regressive model, a moving average model, an autoregressive moving average model, an autoregressive integrated moving average model, a state space model and any combination of the auto regressive model, the moving average model, the autoregressive moving average model, the autoregressive integrated moving average model and the state space model is used.

4. The peak shape estimation device according to claim 1, wherein
the processing unit further includes an area calculator that calculates a peak area with use of the estimation waveform data.

5. The peak shape estimation device according to claim 1, wherein
the estimator acquires the estimation waveform data with use of Bayesian inference.

6. A peak shape estimation device realized by a computer including a processing unit, wherein
the processing unit includes
an acquirer that acquires, based on measurement data acquired over time using an analysis device, measurement waveform data, the measurement data representing a change in domain direction of the measurement data, and
an estimator that estimates noise data included in the measurement waveform data, and
the estimator processes the noise data included in the measurement waveform data as data having a correlation in the domain direction, and detects an abnormality in a case in which a correlation coefficient of the domain direction of the noise data exceeds a predetermined threshold value.

7. A peak shape estimation method including:
an acquiring step of acquiring, based on measurement data acquired over time using an analysis device, measurement waveform data, the measurement data representing a change in time direction of the measurement data; and
an estimating step of acquiring estimation waveform data that is what noise data is at least partially removed from the measurement waveform data, wherein
in the estimating step, a peak shape included in the measurement waveform data is estimated with use of a peak waveform model to which an error term having a correlation in the time direction is added, and the estimation waveform data is thus acquired.

8. A peak shape estimation method including:
an acquiring step of acquiring, based on measurement data acquired over time using an analysis device, measurement waveform data, the measurement waveform data representing a change in domain direction of the measurement data; and
an estimating step of estimating noise data included in the measurement waveform data, wherein
in the estimating step, the noise data included in the measurement waveform data is processed as data having a correlation in the domain direction, and an abnormality is detected in a case in which a correlation coefficient of the domain direction of the noise data exceeds a predetermined threshold value.
